(19) United States
(12) Patent Application Publication
(10) Pub. No.: US 2004/0045290 A1
(43) Pub. Date: Mar. 11, 2004

(54) Rotary crank-rod mechanism

(76) Inventor: Jacques Busseuil, Mesnir Saint Pere (FR)

Correspondence Address: YOUNG & THOMPSON, 745 SOUTH 23RD STREET 2ND FLOOR, ARLINGTON, VA, 22202

(21) Appl. No.: 10/250,446

(22) PCT Filed: Jan. 10, 2002
(86) PCT No.: PCT/FR02/00087

(51) Int. Cl. F16H 21/16; F02G 1/04; F01B 29/10

(52) U.S. Cl. 60/525; 74/25; 74/579 E

(57) ABSTRACT

The invention concerns a mechanism operating according to the principle which states that each point in a circle, running in the circle, describes a rectilinear hypocycloid. Said mechanism which is perfectly dynamically balanced reduces frictions to a minimum, and advantageously replaces conventional crank-rods, whereof the vibrations and frictions of the pistons pressing on the cylinders constitute major drawbacks. It can be used to produce rotary motors, capable of using any heat source, or any fuel, including hydrogen. It can also be used to produce refrigerating machines or heat pumps, using air as refrigerant, or machines for extracting water from air, using solar energy. Finally, it can be used for producing compressors, compressed air engines, hydraulic pups or engines, as well as vacuum cleaners, fans and nautical propellers.

This invention relates to a rotary crank-rod mechanism allowing in particular for continuous internal combustion piston engines or piston engines capable more generally of using any heat source.

The internal combustion engines developed industrially to date are as follows:

Firstly, Diesel or spark-ignition reciprocating engines, either two- or four-stroke, which have the disadvantage, with regard to the conventional crank-rod system, of involving anharmonic movements that are a source of wear, vibrations and noise. Furthermore, in this conventional crank-rod system, the piston necessarily exerts intense pressure on the cylinder due to the inclination of the connecting rod relative to the axis of the cylinder, which gives rise to friction and a loss of efficiency and requires effective cooling and constant lubrication of the cylinder. This type of engine also has the disadvantage that it contains complex related devices to inject and ignite the fuel on each cycle and to open and close valves in the case of a four-stroke engine. More particularly, two-stroke engines also have the disadvantage of poor efficiency.

Secondly, the Wankel engine, which is a rotary engine and does not therefore present any anharmonic movement, but still has an ignition phase with the same disadvantages as above. This engine also uses the properties of a specific bean-shaped cycloid, requiring complex seals, the effectiveness and wear of which have remained poorly mastered, which explains why this type of engine has almost completely disappeared.

Finally, gas turbines, which also do not present any anharmonic movement. The engine cycle does not have an ignition phase and combustion is continuous. However, these turbines only reach optimum efficiency at high rotating speeds and very high temperatures. Furthermore; compression is obtained by the effect of the speed of the air, which gives rise to noise that is difficult to control. Finally, their production cost is high. All this explains why turbines are only used for high power and specific applications.

These three types of engine also have the common disadvantage that they cannot easily be adapted to all types of heat source. They currently operate with fuels the combustion gases of which are pollutants and dangerous for the future of our planet.

This same rotary crank-rod mechanism, the object of the present invention, can also be used to produce refrigerating machines or heat pumps, according to arrangements analogous to those of heat engines, operating in reverse, and using air as a refrigerant. The refrigerating machines and heat pumps that currently exist all have the disadvantage that they use freon type refrigerants that, in the event of unfortunately inevitable leaks, contribute to the destruction of the ozone layer.

This same rotary crank-rod mechanism, the object of the present invention, can further be used in the production of single- or multiple-stage compressors or compressed air engines.

These appliances are not currently reversible, and piston compressors contain automatic valves, which are fragile and a source of noise. As for compressed air piston engines, these have controlled valves, with the same disadvantages. The crank-rod system also has the same disadvantages as those given for heat engines.

With regard to compressors and compressed air engines that operate with vanes, fans, screws, etc., these have the same disadvantages as the turbines mentioned above.

This same rotary crank-rod mechanism, the object of the present invention, can finally be used in the production of hydraulic pumps or motors, as well as vacuum cleaners and fans, according to arrangements analogous to the arrangements of compressors or compressed air engines, operating with a single stage, with a compression ratio of one.

These machines currently operate either with pistons or vanes, with the same disadvantages as those given for compressors or compressed air engines.

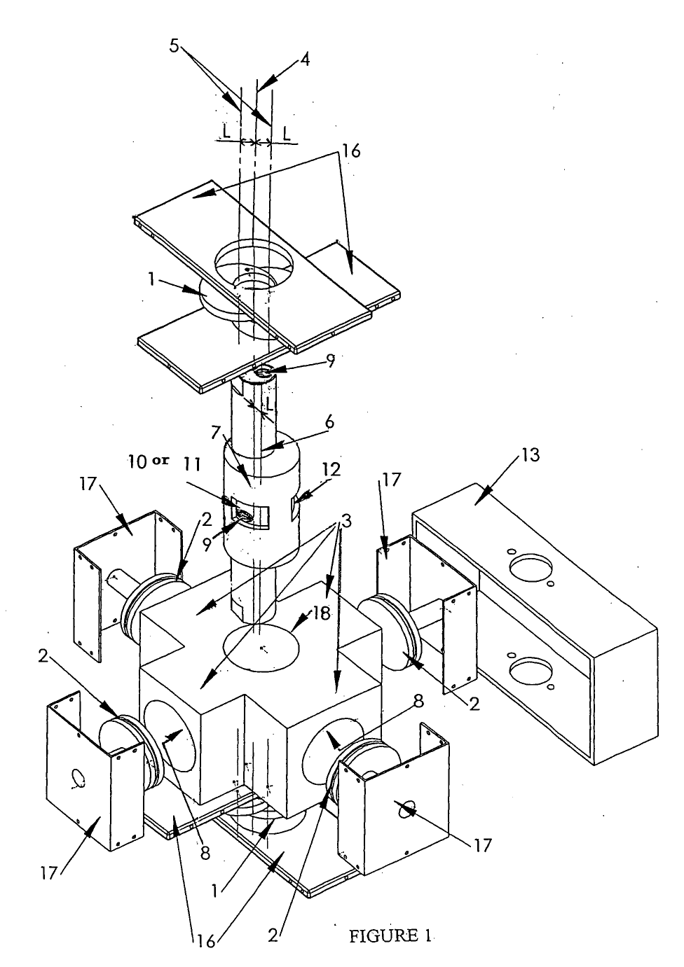

The purpose of the rotary crank-rod mechanism according to the present invention is precisely to provide a technical and industrial solution to the disadvantages set out above, and is characterised by the following general arrangements, illustrated in an exploded view by FIG. 1.

1) Two crankshafts (1) arranged symmetrically on each side of the mechanism and rotating about the same fixed axis (4). These crankshafts support pistons (2) through connecting rods (16) and connecting rod big ends (17) (generally four in number). Their eccentric, the distance between the fixed axis (4) of rotation of the crankshafts and the mobile axes of rotation (5) of the connecting rod small ends, is equal to L. These two crankshafts are connected to each other by a collar or a calliper (13). Each crankshaft is generally made up of two diametrically opposed journals, eccentric by a length L relative to an axial hole receiving a fixed male cylinder, forming part of the central fixed part described below. Four connecting rods, two for each crankshaft, pivot on these two journals; the connecting rods are made up of a flat having an axial hole in which each journal is lodged, and fixing devices for the connecting rod big ends, at its two ends. The connecting rod big ends are made up of a part connecting the ends of the connecting rods in pairs, firmly attached to the piston(s) penetrating the cylinder(s) from outside. The peripheral collar or calliper fits onto the two crankshafts, from the outside, and firmly attaches them to each other. The two crankshafts and the collar (or calliper) thus form a single external crankshaft, receiving the driving torque or receiving receptor of the mechanism. The inverse torque is received by the central fixed part described below. It must be noted that the external crankshaft receives any transmission units.

2) A cylinder block (18) supporting cylinders (3), rotating about a fixed axis (6) parallel to the fixed axis (4) of rotation of the crankshafts, the distance between the two axes also being equal to L. The cylinder block is made up of a female axial cylinder, rotating around a fixed male cylinder, forming part of the central part described below. The cylinders (3) receiving the pistons (2), arranged along two generally orthogonal axes, are attached to the female axial cylinder. In the base of the cylinders (3) there are holes or ports (8) that link the cylinders with the inside of the cylinder block.

2) A fixed central part (7) supporting the axes of rotation (4) of the crankshafts (1), and of the cylinder block (18), the connecting rod small ends thus describing a so-called La Hire rectilinear cycloid, which in fact makes the operation of this mechanism possible, relative to the cylinder block. Sealing devices (15), described below, are provided on this fixed central part. The fixed central part has in its centre a male cylinder located on a fixed axis (6), around which the cylinder block pivots, and, on each side, two male cylinders located on a fixed axis (4), about which the two crankshafts pivot. The axis (4) of these two cylinders and the axis (6) of the first male cylinder are parallel and separated from each other by a length L. Inside the fixed central part are compartments (9) in which a fluid circulates at different relative pressures. It must be noted that on each side of the fixed central part are devices to fix the central part to the fixed frame on which the mechanism is mounted.

3) Pistons (2) sliding in cylinders (3), defining in them compression and/or expansion chambers, opening at the end of the compression phase and/or at the beginning of the expansion phase, through ports (8) in the base of the cylinders, and ports (10) for compression and (11) for expansion made in the fixed central part, into one or more central compartments (9), located inside the fixed central part. The aforementioned compression and/or expansion chambers open to the outside or onto a relatively low-pressure compartment, in the intake and/or exhaust phase, through the aforementioned ports (8) made in the base of the cylinders, and ports (12) made in the fixed central part.

These general arrangements allow for the prevention of any anharmonic movement (rotational movement), the elimination of all wear caused by the pressing of the pistons on the cylinders, which is inevitable with the conventional crank-rod system, and therefore facilitate the lubrication and cooling of the mechanism. Moreover, these general arrangements allow for the use of round or o-ring seals, the effectiveness and wear of which have been completely mastered.

It must be noted that each piston has a 2Lsin zt type elongation in its cylinder and that an offset of a given angle y is observed between the elongations relating to two cylinders forming this same angle y between them (generally Å/2), whilst the connecting rod small ends form between them an angle 2y on the crankshafts (generally Å). Thus, the stroke of the pistons is equal to four times the eccentric, i.e. 4L, the rotating speed of the cylinder block and the pistons is equal to z, whilst the rotating speed of the external crankshaft is equal to 2z, i.e. two times greater.

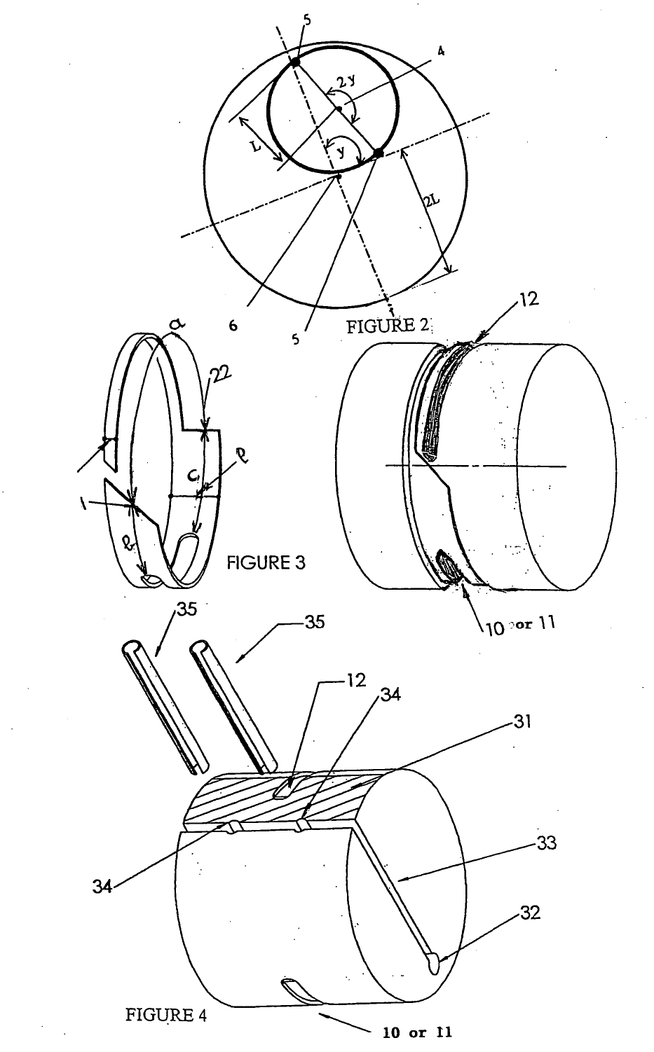

It must also be noted that the axes of rotation (4) of the crankshafts and (6) of the cylinder block are fixed, whilst the axes (5) of the journals pivot about the axis (4) of the crankshafts, as shown on FIG. 2, which shows a theoretical operating diagram in plan view.

Finally, it must be noted that the friction, in the movement of the mechanism, is located firstly at the connecting rod small ends, in their rotations on the crankshafts (generally four rotations), secondly at the centre of the crankshafts pivoting around the fixed central part (two rotations) and finally between the cylinder block and the fixed central part (one rotation). This friction can be minimised either through the use of roller or needle bearings, through the use of bushes on

an oil film, or through friction between compatible materials, for example teflon on steel, carbon on steel, etc. Further friction is observed at the sealing rings.

Moreover, three technical solutions for the sealing devices (15) are proposed below, allowing for the ports between the cylinder block and the fixed central part to be opened and closed when required on the one hand, and for the chambers, in which the fluid is at different pressure levels, to be sealed off from each other on the other hand.

The first solution, illustrated in FIG. 3, which shows part of the fixed central part, consists of a central sealing ring, located on the central part, with an outer diameter equal to the inner diameter of the cylinder block, with a width m on an angle a and a width 1, greater than m, on an angle 2Å-a. A diagonal cut (21) is made at one of the two changes in width, over the entire width of the ring and a straight cut (22) is made at the other change, over a width 1-m. A port (10) or (11) is opened in the widest part of the ring, leaving an angle b between the diagonal cut and the closest edge of the port, and an angle c between the straight cut and the other edge of the port. This ring is arranged in a contour in the fixed central part, following the shape of the ring, and also containing a port (12) located in the same plane as the port (10) or (11) above, opening opposite the port from one edge to the other of the aforementioned contour, on an angle a. Thus, when the cylinder block rotates around the ring, the ports (8) made in the base of the cylinders, in the same plane as above, will successively coincide, in the rotation of the cylinders, first with the angle a and the port (12) opening to the outside or onto a relatively low-pressure compartment, then with the angle b where they will be closed, then with the port (10) or (11) opening onto a high-pressure chamber located in the fixed central part, then with the angle c where they will again be closed. It is the very pressure of the fluid inside the high-pressure chamber that provides the seal between this chamber and the outside on one hand, and the closure of the ports (8) made in the base of the cylinders during the compression and/or

expansion phases on the other hand. It must be noted that, in this solution, the direction of rotation of the cylinder block is not immaterial, and that the order of the parts of the rings before which the cylinders are presented must be adhered to (a, then b, then c). It must also be noted that there will be right-hand rings and left-hand rings, symmetrical with each other. Finally, it must be noted that the bisector of the angle a is perpendicular to the plane of the two axes (4) and (6).

Thus, if the width of the port (8) divided by the radius of the cylinder forming the cylinder block is equal to d, it can be demonstrated that a=Πd, b=d to bring about an expansion and c=d to bring about a compression on one hand, and that the volume compression or expansion ratio is equal to 2/(1+cos(c−b)).

The second solution, illustrated in FIG. 4, consists of the production of a fixed central part with the same outer diameter as the inner diameter of the cylinder block, without clearance and with a perfectly smooth surface state. The radius r of this central part is then reduced by the order of one hundredth of a millimetre, along a strip (31) with an approximate width of Πr/2. A hole (32) is made lengthways in the fixed central part, diametrically opposite the strip (31). A cut (33) is made between this hole (32) and the strip (31). Two holes (34) are made, along this cut, with the same diameter as the hole (32), perpendicular to it and opening onto it. Two tubes (35) open lengthways, with the same outer diameters as the inner diameters of these holes (34) must then simply be inserted into the holes (34). Consequently, the required sealing is provided by the very pressure of this central part on the inside of this cylinder block.

The third solution consists of producing a fixed central part with the same outer diameter as the inner diameter of the cylinder block, with no clearance or micronic clearance, with a perfectly smooth surface state possibly finished with grooves forming labyrinths. Consequently, the required sealing is provided by the pressure of the fixed central part on the inside of the cylinder block or by the narrowness and shape of the space separating the central part and the cylinder block.

Whichever solution is selected, the materials chosen for the cylinder block and the central part must be compatible and be able to slide on each other with minimum friction, which may possibly be minimised by a film of pressurised oil injected into a wedge-shaped space.

There are numerous applications of the general arrangements above, including the embodiments described below:

There are many solutions for producing heat engines using the crank-rod mechanism that is the object of the present invention, using the thermodynamic cycle of conventional spark-ignition engines or Diesel engines, with the ignition or combustion of the fuel taking place in the same chambers as the compression and expansion of the air. The two solutions envisaged below operate with continuous combustion or continuous heat input carried out in a single central chamber located in the fixed central part, or in the fixed housing connected to it. This arrangement has the particular advantage of eliminating any ignition device, allowing more complete combustion of the fuel in continuous combustion engines, and opening up the possibility of using hydrogen as a fuel, which is very difficult to envisage with conventional spark-ignition engines. For a full understanding of the rest of this document, it must be remembered that, in a heat engine, the conversion of heat energy into mechanical energy occurs through a five-phase cycle: intake, compression, combustion, expansion and exhaust. When the five phases take place in a single complete piston stroke, we speak of a “2-stroke” engine; when they take place in two complete strokes, we speak of a “4-stroke” engine. In a conventional spark-ignition engine, either two- or four-stroke, the heat input takes place at a constant volume; in a Diesel engine, the heat input first takes place at a constant volume, then at a constant pressure. In the two solutions envisaged below, the heat input takes place at a constant pressure.

The first solution consists of using two cylinders as compressors and two cylinders, possibly with a different volume to the first two cylinders, as expanders, with heat input taking place at an almost constant pressure, between compression and expansion. The first two cylinders supply a central chamber, located in the fixed central part, with compressed air. The two phases that take place in these cylinders are intake and compression. The other two cylinders remove the compressed air from this central chamber. The two phases that take place in these cylinders are expansion and exhaust. The heat input takes place at a constant pressure in the central chamber. When this input is provided by internal combustion, this operates continuously, as in a boiler, with the fuel, whether this is a liquid or gaseous hydrocarbons or hydrogen, being introduced directly into the central chamber. It is not therefore a spark-ignition engine, but a continuous combustion engine, comparable in this regard to a gas turbine. It must be noted that the port (10) in the first two cylinders, acting as compressors, opens onto one end of the combustion chamber, whilst the port (11) in the other two cylinders, acting as expanders, opens onto the other end of the chamber. An almost constant flow of air is thus created in the central chamber, allowing for the aforementioned continuous combustion.

When the heat input is provided from an external heat source, whether this is solar or nuclear energy, etc., the central chamber is connected to an external chamber in which the compressed air receives the heat input. This central chamber is then split into two compartments, one opening onto the port (10) in the two cylinders acting as compressors, and the other opening onto the port (11) in the other two cylinders acting as expanders. An almost continuous flow of air is thus created from the first to the second compartment, passing through the external chamber.

This solution has certain similarities to a four-stroke engine as each thermodynamic cycle takes place in two times two piston strokes.

It must be noted that this type of engine can be used in particular to supply an external chamber into which the exhaust gases are pushed after expansion, whilst they still have residual pressure. If this chamber opens to the outside through a nozzle, the engine may be used to propel an appliance through a reaction force.

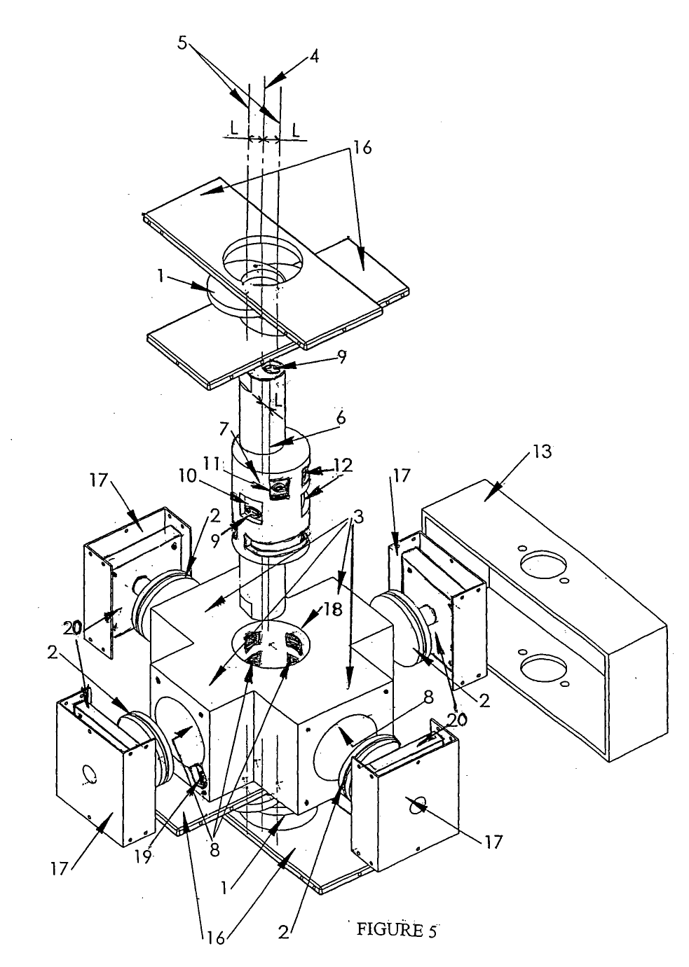

The second solution, illustrated in FIG. 5, consists of using the outer part of each cylinder to draw in fresh air, via a hole (19) made in the wall of the cylinders, linking this outer part of the cylinders to the centre of the cylinder block. This outer part of the cylinders is delimited by cylinder closures (20) equipped with sealed rod packing, in which the piston rods slide. The fresh air drawn in in this way is discharged, through the same hole (19) and a port (8), into the inner chambers of the cylinders at the end of the expansion phase, with the exhaust gases being expelled to the outside through another port (8) at the same time. To achieve this, each cylinder therefore has two ports (8), one facing the port (10) that opens at the end of compression, and the other facing the port (11) that opens at the beginning of expansion. These ports, located on the fixed central part, communicate with the central chamber, in which the heat input occurs. As in the previous case, the port (10) communicates with one end of the combustion chamber and the port (11) communicates with the other end, with a flow of air taking place from the port (10) to the port (11), passing through the central chamber, allowing for continuous combustion. As in the previous case, this engine can operate from an external heat source, with the same arrangements as above, with the aim of externalising the central chamber.

In the inner part of each cylinder, on each complete piston stroke, the sweeping out of the hot gases by fresh air, the compression of this fresh air, and the expansion after heat input take place in succession.

This solution therefore has certain similarities with a two-stroke engine. It will have the advantage, compared with the previous case, of delivering a very even driving torque, even at very low rotating speeds.

It must be noted that this engine can be started simply by supplying compressed air at the intake. In fact, this compressed air will act on the outer part of the pistons due to the positive pressure difference between the intake and the exhaust.

It must also be noted that these engines are suitable for mounting directly in a wheel or propeller. To this end, the two crankshafts are jointly connected to this wheel or this propeller, to which they transmit the rotational movement directly without an intermediate transmission unit.

In this case, the power of the engine is varied by supercharging. To this end, it is possible to compress the fresh air by expansion of the exhaust gases. This compressed fresh air will then be cooled by heat exchange with the outside, before supplying the engine. To do this, it is practical to use an independent device using the same rotary crank-rod mechanism that is the object of the present invention, allowing for variable fresh air compression ratios and exhaust gas expansion ratios to be obtained by movement of the cylinder block along the fixed central part. To this end, a mechanism is used with four piston-cylinder pairs, characterised in that two of the aforementioned pairs define variable ratio expansion chambers, receiving the hot gases from the engine, in which they have undergone an initial expansion, and the other two pairs form variable ratio compression chambers, receiving fresh air and subjecting it to an initial compression before cooling and injection into the engine.

The two solutions set out above for heat engines may be used, according to the same arrangements, to produce refrigerating machines or heat pumps, using air as a refrigerant. Two differences between these devices and heat engines must be highlighted. The first relates to the compression ratio sought. It is as high as possible for heat engines (for example, compression ratio of 15, pressure ratio of 45, temperature ratio of 3), in order to obtain maximum efficiency. Conversely, this compression rate is as low as possible for refrigerating machines or heat pumps (for example, compression ratio of 2, pressure ratio of 2.6, temperature ratio of 1.3) in order to obtain a maximum coefficient of performance.

The second difference relates to the heat exchange in the chamber (9). Heat is supplied for engines, whereas heat is removed for refrigerating machines or heat pumps. To this end, the chamber (9) will be externalised, as in the case of the heat engine using an external heat source, with the compressed air being expelled and the air reintroduced after cooling. The corollary of this heat removal is that the refrigerating machines or heat pumps must be driven by an electric motor, a heat engine, a wind power engine or a also water turbine.

Refrigerating machines designed in this way will be able to pump the air from inside a cold chamber, compress it so that it reaches a higher temperature than the outside temperature, cool it by heat exchange with the outside, and then expand it and reintroduce it into the cold chamber. The advantage of this device is that, at the same time, the condensation water can be collected just before the expansion phase. The air will thus be dried, which will reduce frost formation phenomena in the cold chamber. Heat pumps designed in this way will be able to pump the cold outside air, compress it until it reaches a higher temperature than the room or water to be heated, cool it by heat exchange with the room or water, and then expand it and re-eject it outside. The condensation water may also be collected before the expansion phase. As in the previous case, this arrangement has the advantage of reducing frost formation phenomena.

A major application of the arrangements above consists of the union of a refrigerating machine and a heat engine, in order to produce water, extracted from the air, using solar energy for example. To this end, the same arrangements as above will be used, without any modification in mechanical terms. The difference lies in the heat exchanges carried out in the chamber (9). This is externalised, as for the refrigerating machines. The outside air is first compressed, and then cooled at a constant pressure by heat exchange with the outside. The condensation water is then collected. After a possible second compression stage, the dried air is then heated by solar energy, by passing into a Pyrex or equivalent enclosure onto which the sun's rays are concentrated by any appropriate means (parabolic mirrors, magnifying glasses, etc.). The air is then expanded before being re-ejected outside. The heating by solar energy simply has to compensate, in volume, for the cooling of the first heat exchange and the water loss, for the assembly to be autonomous. The practical consequences of such an application are very significant, as it is thus possible to produce water in the middle of the desert, with a particularly unsophisticated technology.

With regard to compressors or compressed air engines, these are directly derived from the general arrangements. When four cylinders are identical, the compressor or the compressed air engine is single-stage, which is suitable for pressure ratios varying approximately from one to forty, or even more if the piston stroke is long.

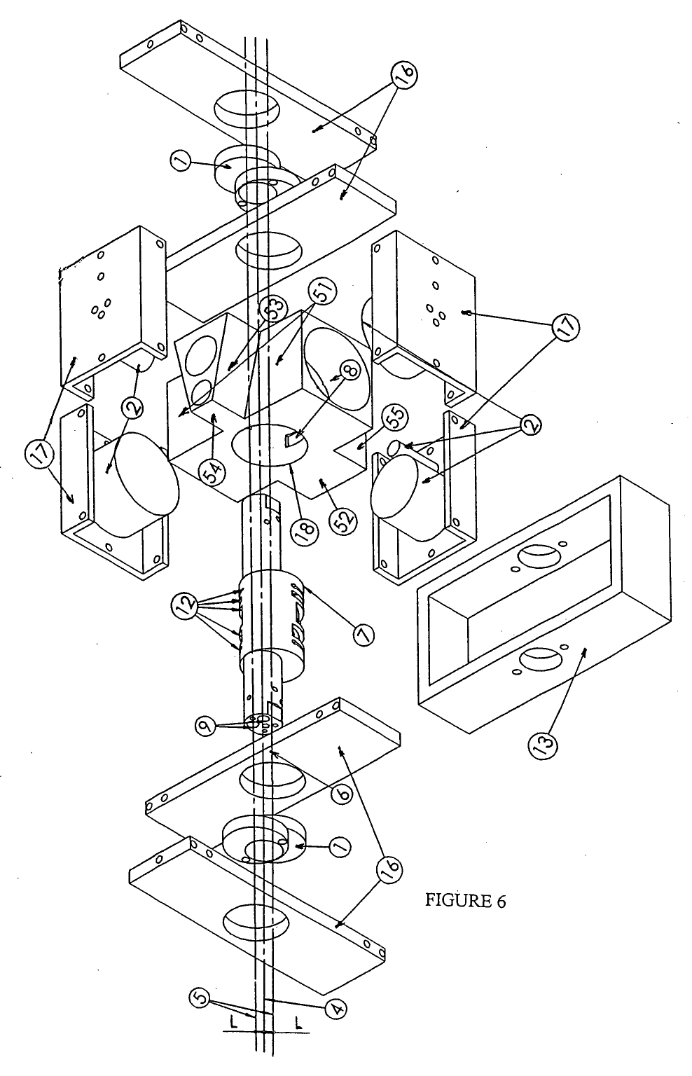

When a higher pressure ratio is required, for example for diving equipment using 200 bar, or more generally for any equipment requiring a minimum of autonomy (i.e. vehicles running on compressed air), it becomes necessary to provide several compression or expansion stages, without omitting a heat exchange with the outside between each stage, so that the compression or expansion is close to the isotherm. For example, FIG. 6 shows an exploded view of a five-stage compressor or compressed air engine. The first stage is made up of the two largest cylinders (51), the second stage is made up of the cylinder (52), the third by the cylinder (53), the fourth by the cylinder (54) and the fifth by the cylinder (55), which is the smallest. The chambers located in the fixed central part are extemalised and open onto heat exchangers that exchange heat with the outside.

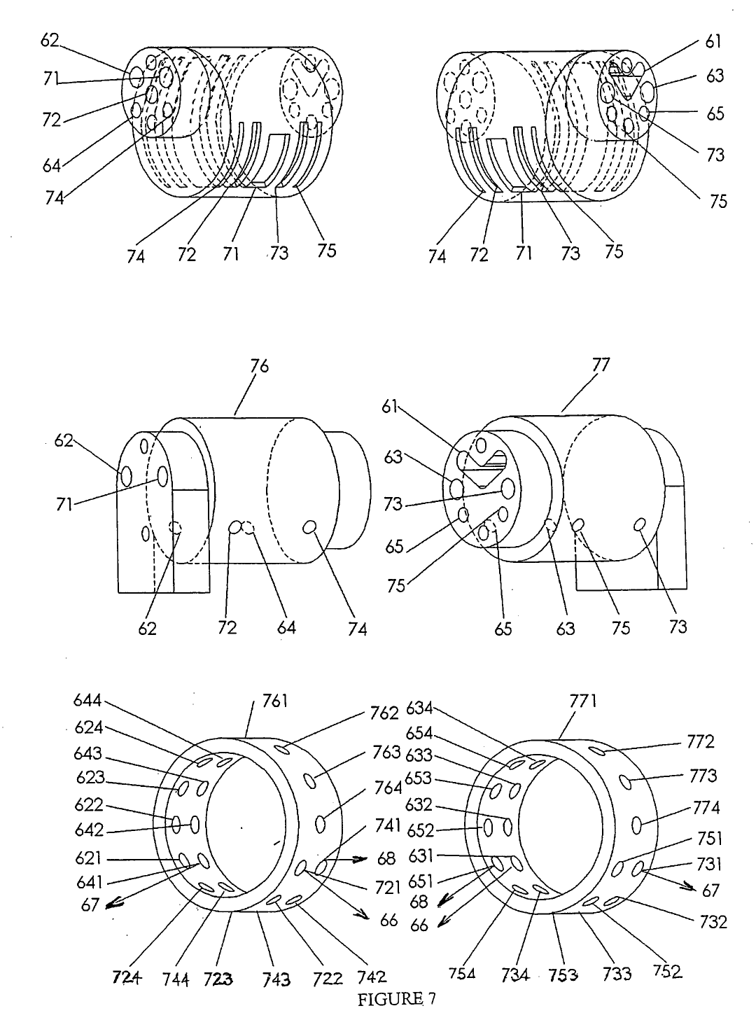

The air circuit can be modified by rotating these exchangers around the fixed central part, so that the five-stage compressor or basic engine can also operate with four stages (in this case, the cylinder (55) is linked to the cylinders (51)), three stages (in this case, the cylinder (55) is linked to the cylinder (52) and the cylinder (54) is linked to the cylinders (51)) or two stages (in this case, the cylinders (55) and (53) are linked to the cylinders (51) and the cylinder (54) is linked to the cylinder (52)). These arrangements, provided by a rotary distributor shown in FIG. 7, allow for the operation of the engine or compressor to be adapted to the variable pressure in the compressed air reservoir. For the compressed air engine, they also allow for the power of the engine to be varied at will, whatever the pressure in the reservoir.

This rotary distributor is achieved through a fixed central part, continuing on from the two lateral cylinders on the fixed central part, on each side of the mechanism, and a pivoting peripheral section, with three heat exchangers that exchange heat with the outside. These three exchangers are identified as (66), (67) and (68). The air intakes and outlets are identified as (61) and (71) for the first stage, (62) and (72) for the second, (63) and (73) for the third, (64) and (74) for the fourth, and finally (65) and (75) for the fifth.

The outside air intake (61) is located directly at the end. The outlet (71) is located at the other end, and communicates with the intake (62) through a fixed heat exchanger. The intake (62) communicates on the one hand with the compartment of the second compression stage in the fixed central part, and on the other hand with a port (62) on the periphery of the fixed central part, at 120 degrees from a reference generator in which there are two final compressed air outlets (76) and (77) on each side of the mechanism. The intakes/outlets (63) to (65) and (73) to (75) respectively communicate on the one hand with the compartments in the third, fourth and fifth stages in the fixed central part, and on the other hand

with ports with the same numbers, on the periphery of the fixed part, arranged at 120 degrees relative to the reference generator for the intakes (63), (64) and (65), and at −120 degrees relative to the same generator for the outlets (72), (73), (74) and (75). There are ports on the pivoting peripheral section arranged on the same planes as the above ports, with those that are identified by the same number followed by 1 facing them, those that are identified by the same number followed by 2 offset by 30 degrees, those that are identified by the same number followed by 3 offset by 60 degrees, and finally those that are identified by the same number followed by 4 offset by 90 degrees.

Ports (621), (761) and (771) are blocked.

Port (721) is connected to port (631) by the exchanger (66).

Port (731) is connected to port (641) by the exchanger (67).

Port (741) is connected to port (651) by the exchanger (68).

(751) is connected to (771), (722) to (721), (632) to (631), (731) to (731), (642) to (641), (742) to (772), (752) to (651), (622) to (641), (652) to the outside, (723) to (721), (633) to (631), (733) to (773) and to (732), (641) to (763), (753) to (633), (643) to the outside, (743) to (623), (653) to (651), (623) to (741), (724) to (764) and to (721), (774) to (631) and to (731), (754) to (651), (624) to (741), (654) and (634) to the outside, (644) to (624), (754) to (651), (624) to (741), (744) to (724) and (734) to (754).

Consequently, when the ports in the fixed section are facing the ports with the same number followed by 1, the compressor or the engine is operating with five compression or expansion stages, when they are facing the ports with the same numbers followed by 2, four stages, when they are facing the ports with the same numbers followed by 3, three stages, and finally, when they are facing the ports with the same numbers followed by 4, two stages. The transfer from one operating mode to another is carried out by rotating the moving section by 30 degrees.

It must be noted that the cross sections of the various ports and pipes are calculated so that the fluid circulation speeds are uniform. These cross sections will therefore be larger on the first stage than on the second, on the second than on the third, etc., in inverse proportion to the pressure.

When a single-stage compressed air engine or compressor has a compression ratio of one, it is possible to produce pumps or hydraulic motors, or even vacuum cleaners or fans, by increasing the relative dimensions of the fixed central part, without any other modification. Increasing the relative dimensions of the fixed central part has the advantage of providing an almost constant cross section of flow of the fluid, of the same order as the cross section of flow of the cylinders. The intake ports in the cylinders then have the same cross section as the cylinders themselves.

It must be noted that, for four cylinders, the flow rate of the fluid is then described by sin zt+cos zt, for zt between 2kΠ and 2kΠ+Π/2. Thus, this flow rate passes through a minimum equal to 1, for zt=0, and a maximum equal to 1.414 for zt=Π/4.

It is possible to equalise this flow rate either by increasing the number of cylinders, for example 8 cylinders offset by ΠΠ/4 (it is demonstrated that, in this case, the flow rate varies from 1 to 1.09), or by adding compensators made up of an air chamber or a spring-mounted piston, absorbing the variations in flow rate.

A useful application of the above arrangements will be formed by the union of a compressed air engine and a water pump. Returning to FIG. 6, for example, the first stage can be used as a water pump, whilst stages five, four, three and two can be used as a compressed air engine, actuating the water pump. The air expelled by the second stage must simply be injected into the water, downstream of the pump, to obtain a nautical propeller.

1) Rotary crank-rod mechanism comprising a fixed central part (7), supporting two crankshafts (1) arranged symmetrically on each side of the mechanism, rotating about a fixed axis (4), this same central part also supporting a cylinder block (18) receiving piston-cylinder pairs, rotating about another fixed axis (6), the pistons (2) being connected to the crankshafts (1) by connecting rod big ends (17) and connecting rods (16), pivoting around two journals, the mobile axes (5) of which are in opposition on each crankshaft, characterised in that the mobile axes (5) of the journals are eccentric relative to the fixed axis (4) of the crankshafts, by a length L equal to the distance between the aforementioned fixed axis (4) and the fixed axis (6) of rotation of the cylinder block (18), all of these axes being parallel with each other.

2) Mechanism according to claim 1, characterised in that it has sealing devices (15) located on the fixed central part, made up of a diagonally cut ring, with an outer diameter equal to the inner diameter of the cylinder block, located in a contour in the fixed central part, characterised in that the ring has two changes in width, one at the diagonal cut (21), and the other at a straight cut (22), ports having being made firstly in the base of the cylinders (8), secondly on the same plane on the ring in line with a high-pressure chamber located in the fixed central part (10 or 11), and finally on the contour of the fixed central part, still on the same plane, opposite the previous port, opening to the outside or into a relatively low-pressure chamber (12).

3) Mechanism according to claim 1, characterised in that it has sealing devices (15) between the fixed central part and the cylinder block, obtained by the pushing aside of the central part inside the cylinder block, characterised in that, as the outer diameter of the central part is the same as the inner diameter of the cylinder block, a lengthways strip (31) of the central part is reduced, a lengthways hole (32) is made opposite this strip, a cut (33) is
made between the hole and the strip, and two holes (34) with the same diameter as the first are made perpendicular to it, along the cut (33), on each side of ports (10 or 11, and 12) to be sealed, two tubes (35) being inserted inside the two holes (34).

4) Mechanism according to claim 1, characterised in that it has sealing devices between the fixed central part and the cylinder block, characterised in that, as the outer diameter of the central part is the same as or slightly smaller than the inner diameter of the cylinder block, the sealing is obtained by the dimensional characteristics of the space between the fixed central part and the cylinder block, with labyrinthine grooves possibly being made around the ports to be sealed.

5) Mechanism according to any one of claims 2 to 4, applying to a rotary heat engine with four piston-cylinder pairs, characterised in that two of these pairs define compression chambers and the other two define expansion chambers, opening at the end of compression and at the beginning of expansion, through ports, onto a single central continuous combustion or continuous heat input chamber, located in the fixed central part.

6) Mechanism according to claim 5, characterised in that the exhaust gases have positive residual pressure and are expelled through a nozzle, allowing for a reaction propulsion force to be generated.

7) Mechanism according to any one of claims 2 to 4, applying to a rotary heat engine with four piston-cylinder pairs, characterised in that these pairs each define compression/expansion chambers on the side of the central fixed part and ventilation chambers on the opposite side, the first opening at the end of compression and at the beginning of expansion, through different ports (10 and 11), onto a single central continuous combustion or continuous heat input chamber, located in the fixed central part, and the second, defined by cylinder closures (20) opening through holes (19)
onto the first between the expansion phase and the compression phase, in order to ensure that the hot gases are swept out after expansion.

8) Mechanism according to claim 5 or 7, characterised in that the two crankshafts are placed at the centre of a wheel or a propeller, to which they are jointly firmly connected, and transmit the rotational movement directly without an intermediate transmission unit.

9) Mechanism according to claim 7, characterised by a compressed air starting device, obtained by a positive pressure difference between the intake and the exhaust.

10) Mechanism according to any one of claims 2 to 4, with four piston-cylinder pairs, applying to the supercharging of a heat engine, characterised in that two of the aforementioned pairs define variable ratio expansion chambers receiving the hot gases from the engine, where they have undergone initial expansion, and the other two pairs define variable ratio compression chambers receiving fresh air and subjecting it to initial compression before cooling and injection into the engine.

11) Mechanism according to claim 5 or 7, driven by an electric motor, a heat engine, a wind power engine or a water turbine, characterised in that the heat input in the central chamber, for engines, is replaced by heat removal, such mechanism then applying to refrigerating machines or heat pumps.

12) Mechanism according to claim 11, used to extract water from air by condensation after compression and cooling, characterised in that this air is then reheated, for example using solar energy, after a possible second compression stage, before being expanded, the energy input allowing for the aforementioned cooling and loss of water to be compensated for in terms of volume, and thus ensuring the autonomy of the machine.

13) Mechanism according to any one of claims 2 to 4, applying to compressors or compressed air engines, characterised in that the pistons and
the cylinders define compression chambers for compressors and expansion chambers for engines, opening at the end of compression or the beginning of expansion onto one or more central chambers arranged in one or more stages, located in the fixed central part, such central chambers opening between each stage onto an external heat exchanger.

14) Mechanism according to claim 13, characterised in that the central chambers open onto a rotary distribution device, allowing for the number of compression or expansion stages to be varied in order to adapt the operation of the compressor or engine to the pressure of the compressed air, considered as variable.

15) Mechanism according to claim 13, applying to pumps, hydraulic motors, vacuum cleaners or fans, characterised in that the compression or expansion of the fluid occurs in one stage, with a compression ratio of one, the ports (8) made in the cylinder bases having the same cross section as the cylinders themselves.

16) Mechanism according to claim 13, with several stages, characterised in that the first stage is used as a water pump, with a compression ratio of one and ports (8) in the cylinder bases with the same cross section as the cylinders, whilst the other stages are used as a compressed air engine, the expelled air being injected into the water, downstream of the pump, where it undergoes a final expansion, allowing for the speed of ejection of the water through a nozzle to be increased, the mechanism then applying to a nautical compressed air propeller.
